(19) United States
(12) Patent Application Publication
(10) Pub. No.: US 2010/0009086 A1
(43) Pub. Date: Jan. 14, 2010

(54) RAPID CURE COATING SYSTEM

(75) Inventors: Bang T. Tran, Sugar Land, TX (US); Aaron Schiflett, Katy, TX (US)

Correspondence Address: BARNES & THORNBURG LLP, 11 SOUTH MERIDIAN, INDIANAPOLIS, IN, 46204, US

(73) Assignee: BERRY PLASTICS COPRPORATION, Evansville, IN (US)

(21) Appl. No.: 12/499,388

(22) Filed: Jul. 8, 2009

Related U.S. Application Data
(60) Provisional application No. 61/079,044, filed on Jul. 8, 2008.

(51) Int. Cl. C08L 63/00; B05D 3/00

(52) U.S. Cl. 427/386; 523/400; 523/457

(57) ABSTRACT

A composition and coating made thereof for application onto metallic substrates is described. The composition and coating made thereof comprises a resin can be applied to a substrate with sufficient thickness to provide protection to the pipe.

This application claims priority under 35 U.S.C. § 119(e) to U.S. Provisional Application Ser. No. 61/079,044, filed Jul. 8, 2008 which is expressly incorporated by reference herein.

### BACKGROUND

The present disclosure relates to a coating system that forms a film on a substrate. More specifically, the present disclosure relates to a coating system that includes a coating that is formulated to form a film that protects metal pipes and other metal structures from corrosion when they are placed underground.

Pipes, conduits, and other metal substrates require a coating that withstands corrosion and other physical deterioration over time. Such coatings help to preserve the integrity of the substrates because they protect its surface from corrosive elements. This increases the useful life of the substrates. It also reduces costs associated with repair and maintenance.

Various types of coating are known in the art. These include fusion-bonded epoxy powder, extruded bitumen/polyethylene tape wraps, heat-shrink sleeves, and two-part liquid epoxies. They are applied to the substrate with rollers, sprayers, and brushes. In many instances, the coating is applied to the substrate at the manufacturing plant. This resolves many issues that may occur if the coating is applied in the field. For example, the coating can be applied under controlled conditions (e.g., constant temperature), and the substrate surface is kept cleaner that it would otherwise be in the field.

Despite the controlled conditions in the plant, defects can occur when the coating is applied to the substrate. Defects can lead to structural damage to the substrate if it is installed with the defect in place. To avoid these issues, the substrates are generally inspected and repairs made to the coating on the substrate. Common repairs include recoating the substrate at the manufacturing plant, or, patching the pipe with an additional coating.

In addition to defects in the coating, corrosion can also occur where a portion of the substrate is purposely left uncoated. For example, when adjoining to adjacent sections of metal pipe, the uncoated portion is often left to allow for a weld that attaches the two pipes. The uncoated portion is typically from about 6 inches to about 12 inches from the end of the pipe.

After the pipes are welded together, it is often necessary to prepare the weld and the uncoated portion of the pipe, e.g., by sandblasting, before the coating is applied to the weld joint. This type of coating may be applied on-site.

The present disclosure relates to coatings that may be used for repairing defects or coating the uncoated portion of the pipe and the weld joint.

### SUMMARY

According to the present disclosure, a coating system is described that includes a coating that is formulated to form a film that protects metal pipes and other metal structures from corrosion when they are placed underground.

In illustrative embodiments, a coating system comprises a base composition including an epoxy and a curing agent mixed with said epoxy, wherein the film has a durometer hardness of at least about Shore D 75 after curing for less than about 120 minutes. In one embodiment, a coating system comprises a base composition including a first amount of an epoxy having a reaction product including bisphenol A and epichlorohydin, and a second amount of a curing agent mixed with said epoxy and including an alkyl amine, wherein said first amount and said second amount are selected so as to cause the coating film to have a durometer hardness of at least about Shore D 75 after curing for less than about 120 minutes. In another embodiment, the coating system is used to form a coating film on a metallic substrate.

In illustrative embodiments, a method for sealing a substrate comprises mixing a base composition having a first amount of an epoxy and a second amount of a curing agent in a ratio that does not exceed 3:1 and forming a film on the substrate having a thickness of less than about 60 mils and a durometer hardness of at least about Shore D 75 in less that about 120 minutes.

### BRIEF DESCRIPTION OF THE DRAWINGS

The detailed description particularly refers to the accompanying figures in which:

FIG. 1 is a side, perspective view of a section of a pipe with an example of a coating made in accordance with the present disclosure applied thereon; and

FIG. 2 is a flow diagram depicting a method for sealing a substrate with a coating made in accordance with the present disclosure.

### DETAILED DESCRIPTION

The present disclosure relates to a coating system that forms a film on a substrate. More specifically, the present disclosure relates to a coating system that includes a coating that is formulated to form a film that protects metal pipes and other metal structures from corrosion when they are placed underground.

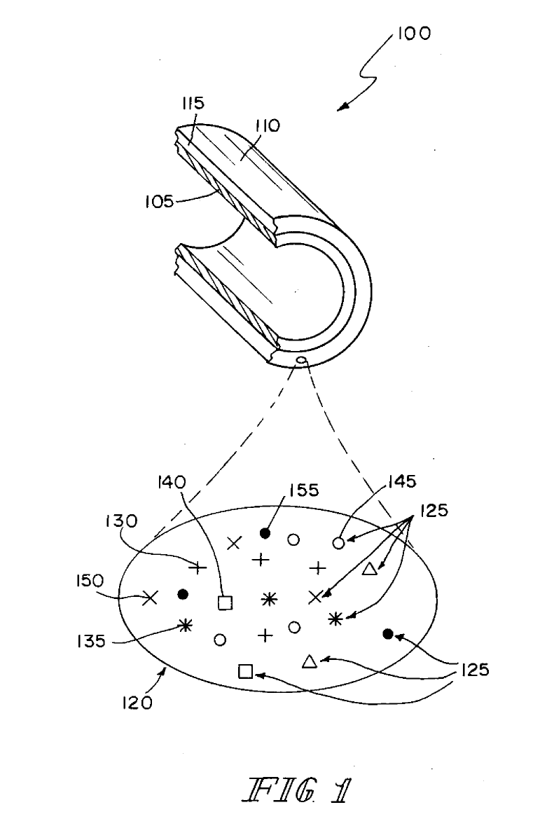

Referring now to the drawings, FIG. 1 illustrates an example of a coating system 100 that is made in accordance with concepts of the present disclosure. Coating system 100 includes a substrate 105 and a film 110 with a film thickness t that is formed from a coating 115 that is applied to substrate 105. As discussed in more detail herein, coating 115 includes a base composition 120 with constituent components 125 that are selected so as to cause film 110 to exhibit physical properties that are substantially superior to some of the physical properties of the prior art. Constituent components 125 in embodiments of coating system 100, for instance, are selected in a manner that causes film 110 to reach a durometer hardness of about Shore D 75 in less than about 120 minutes when coating 115 is cured at a predetermined temperature. This is significantly faster than the time required by other coatings to form films with similar film thicknesses that exhibit similar durometer hardness under similar conditions.

In addition to being selected to form films that cure faster and/or harder than many other comparable coatings, the constituent components 125 that are used in base composition 120 are selected to cause coating 115 to have an unexpectedly low viscosity. Thus, there may be less resistance to the user, e.g., a construction worker, when the constituent components 125 are mixed together to form coating 115. Furthermore, coating 115 does not substantially sag, run, or otherwise slough from substrate 105 before it cures to film 110. Examples of coatings found in embodiments of coating system 100, for instance, do not substantially sag, run, or slough, even when they are applied to substrates that are at a highly elevated temperature. This reduces the amount of coating 115 that is required to create a film that has a thickness between about 0.001 mils and about 100 mils because most of coating 115 is retained on substrate 105. This is also beneficial because coating systems, like coating system 100, that reduce material run-off from the substrate may effectively reduce the amount of coating 115 that is wasted after it is applied to the substrate. This, in effect, may reduce the costs that are typically associated when coating systems like coating system 100 are used to seal, and/or safeguard, pipes, conduits, and other similar structures.

Examples of the physical properties of film 110 and/or coating 115 of embodiments of coating system 100 are illustrated in the Examples. These include data from comparative experiments that illustrate the benefits of embodiments of coating system 100 that include coatings where the base composition is made in accordance with concepts of the present disclosure.

Constituent components 125 may include, but are not limited to, organic resins, chemical activators, as well as other compounds and fillers that may enhance one or more features of coating system 100. In the present embodiment of coating system 100, coating 115 includes an organic resin 130 and a chemical activator 135 that reacts with organic resin 130. Alternative embodiments of coating system 100, however, may also include filler materials 140, plasticizers 145, dyes 150, and pigments 155. Each is combined with organic resin 130 and chemical activator 135 to form base composition 120, as desired.

Organic resin 130 is typically a thermosetting polymer, such as, for example, an epoxy. Preferred epoxies that are used as organic resin 130 of base composition 120 include the reaction product of bisphenol A and epicholorohydrin. These compounds are well-known in the art, as are the chemical processes and mechanisms that are generally involved when these compounds are combined to form the reaction product that is found in the organic resins, e.g., organic resin 130. Therefore, no additional details will be discussed herein about these compounds, unless necessary to clarify or explain an example or embodiment of the coating systems contemplated by the present disclosure. It will be recognized by those having ordinary skill in the art, however, that the reaction product that results may be mixed with other compounds, e.g., inorganic compounds, to form the organic resin that is used as organic resin 130. In a preferred embodiment of coating system 100, the reaction product accounts for less than 45% by weight of organic resin 130.

Chemical activator 135 is often a type of catalyzing agent that reacts with organic resin 130. Chemical activators are known in the art. They are often selected to cure the base composition. As used herein, the term “cure” and any derivative term thereof (i.e., “cures,” “cured,” “curing,” “curative,” etc.) may refer to a process by which a liquid or semi-solid resin hardens or becomes solidified. Curing may occur with the help of an additive, such as a hardener or catalyst. A mechanism of curing may comprise the crosslinking of polymer molecules, a chemical reaction, a bond formation, introduction of intramolecular forces (such as hydrogen bonds), or any other mechanism of attractive force or structure feasible in the context of the present disclosure. Those having ordinary skill in the art will readily appreciate the function of the chemical activator in this process. So, no additional details will be provided herein of the chemical reactions that occur when chemical activator 135 is mixed with organic resin 130 to form coating 115.

The chemical activator used as chemical activator 135 may be selected to facilitate curing of coating 115 so as to form film 110 with the physical properties discussed herein. An example of one type of chemical activator is discussed in more detail in connection with the Examples. It will be further understood that other examples of a suitable chemical activator for use as a chemical activator 135 include derivatives of ammonia, e.g., amines, that are compatible with the compound that is selected for use as organic resin 130. Suitable amines include, for example, diamines that react with the organic resin to create a crosslinked polymer. Other amines that can be used as chemical activator 135 include aminoethylpiperazine, tetraethylene pentamine, alkylamines, and other polyamine that have more than one amine group.

The amine selected for use as chemical activator 135 in embodiments of coating system 100 may include one or more inorganic additives, e.g., filler materials, nitrates, pigments, among others. The amine may also include an organic additive, such as, for example, a dye, an organic nitrate, ethanol. Examples of each of these additives are discussed in more detail herein.

Filler material that is used as filler material 140 may be necessary to add bulk to coating 115 and/or to decrease the cost of coating system 100. The filler material may also modify, enhance, and/or cause one or more of the physical properties of the resultant film or coating. For example, the filler material selected for filler material 140 may absorb the exotherm connected with the chemical reaction of organic resin 130 and chemical activator 135 when mixed together to form coating 115. This may decrease the possibility of cracking in film 110. Other filler materials used as filler material 140 are selected because it decreases the likelihood that shrinkage will occur in film 110. While still other materials for filler material 140 increase the compressive and flexural strengths of the resultant film.

It is further noted that the filler material that is used as filler material 140 should not substantially affect the way that coating 110 is applied to the substrate, e.g., substrate 105. Certain embodiments of coating system 100 include filler materials that are selected so as to permit coating 115 to be applied to substrate 105 via a spray applicator. Examples of suitable filler materials that filler material 140 can be include, but are not limited to, calcium carbonate, silica flour, zeospheres, talc, and kaolin, among others.

Plasticizers that are suited for use in embodiments of coating system 100 may lower the glass transition temperature of the base composition. Some plasticizers, for example, may cause the glass transition temperature to approach the use temperature. Dyes that dye 150 can be, but not necessarily, colored organic chemicals that dissolve in the base composition. Selecting certain ones of such dyes cause the base composition to exhibit physical properties, as desired. For example, dyes that are typically found in coating system 100 are selected to modify the appearance of coating 115. Certain dyes that are added to the based composition may, for example, cause the resultant coating and/or the resultant film to exhibit a specific color, e.g., blue, teal, red, as desired.

Pigments that are used as pigment 155 in embodiments of coating system 100 are selected that cause coating 115 to become opaque. Other pigments are selected to prevent the penetration of UV light beyond the surface of film 110. They are typically finely divided solids that are mixed with the other constituent components of the based composition to change the visual properties of coating 115. Examples of pigments that pigment 155 can be include, but are not limited to, titanium dioxide, calcium carbonate, and any combination thereof. In one example, titanium dioxide is added to the based composition so as to cause coating 115 to become opaque white.

Despite not being discussed in the present disclosure, it is noted that other additives are also suited for use in the based composition of coating 115 of coating system 100. The additives discussed herein are provided for exemplary purposes only. This disclosure contains a non-exhaustive recitation of materials that are suited for use in embodiments of coating system 100.

In many embodiments, the amount of organic resin 130 and the amount of chemical activator 135, as well as the amounts of filler material 140, plasticizer 145, dye 150, and pigment 155, are selected so as to cause coating 115, and/or film 110, to exhibit one or more of the physical properties discussed herein. In one example, the amount of organic resin 130 and the amount of chemical activator 135 are selected in a ratio that does not exceed 3:1. In another example, about 100 parts of organic resin 130 is mixed with about 36 parts of chemical activator 135. In yet another example, about 100 parts of organic resin 130 is mixed with about 50 parts of chemical activator 135.

Components of the coatings that are used in the art may be difficult to combine and pour because they have a high viscosity. As a result, workers must expend time and energy when they prepare the coating. This results in lost time that could be used on other repairs.

Prior art coatings may also require lengthy cure times. As a result, the cost of the project can increase significantly because the curing process delays “backfilling,” or, the process used to fill the trenches with the excavated earth. Other concerns include questions about the structural integrity of the coating. At low ambient temperatures, for instance, typical coatings do not offer sufficient impact strength to withstand the forces applied to the pipe during the backfilling process. Coating the substrate, moreover, with an unequal distribution of coating may result in exposed metal surface, and therefore, higher maintenance costs.

One aspect of the present disclosure is a coating formulated such that there is little dripping, sagging, or running of the coating material at a standard coating thickness of about 30 mils. Another aspect of the present disclosure are coatings that cure rapidly at ambient temperatures, e.g., temperatures from about 22° C. to about 25° C. They should also exhibit high impact strength at ambient temperatures. There is also a need for a coating that does not drip, sag, or run when applied to the substrate at the standard coating thickness of about 30 mils.

In addition to the benefits discussed herein, embodiments of coating system 100 that are made in accordance with concepts of the present disclosure exhibit a substantially durable adhesion to metals, metal pipes, and other metallic structures. This is particularly important because it is common to install pipes underground. For example, during the process used to install pipes and similar conduits, such pipes are laid in a trench. The earth that was excavated from the trench is replaced. This is known as “backfilling.” The films used to seal the pipes must maintain their integrity when the earth is replaced in the trench. It would be understood in the industry that coatings that exhibit a durometer hardness of about Shore D 75 and can pass an impact drop of a minimum of 1 in-lb/mil of coating thickness within a coating thickness range of between about 25 mils and about 35 mils.

Certain embodiments of the coating system are also substantially corrosion and/or chemical-resistant. Exemplary coatings made in accordance with the concepts discussed herein are resistant to such substances as kerosene, diesel, gasoline, sodium carbonate, sodium hydroxide, sodium chloride, nitric acid, hydrochloric acid, sulfuric acid, acetic acid, any other chemical feasible in the context of the present disclosure, or any combination thereof. These properties are typically measured by resistance to corrosion, resistance to discoloration, resistance to chemical reaction, any other resistance measurement feasible in the context of the present disclosure, or any combination thereof.

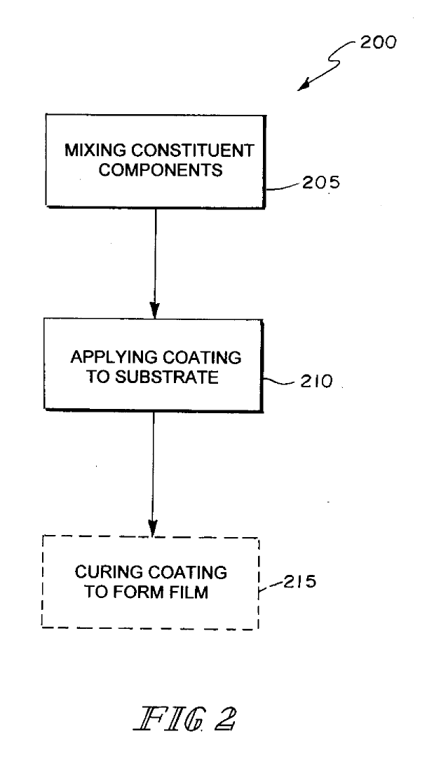

FIG. 2 is an example of a method 200 of sealing a substrate with a coating (e.g., coating 115 (FIG. 1)) that is found in a coating system that is made in accordance with the present disclosure. At step 205, method 200 includes mixing the constituent components of the base composition to form the coating that is applied to the substrate. This may include manual, automated, and semi-automated techniques and/or mechanisms. Skilled artisans will recognize the wide variety of methods that are applicable to coatings used in embodiments of the coating systems discussed herein. In one example method, the constituent components include two separate component mixtures that are combined in a container, e.g., a bucket, and mixed together by hand. In another example, the combination of the organic resin, chemical activator, and filler material is heated and then pumped to a mixer where the components are mixed to form the coating of the coating system made in accordance with the present disclosure. The mechanisms used to heat, pump, and mix, the components will be readily appreciated by those skilled in the art.

In illustrative embodiments, method 200 includes applying the coating to the substrate at step 210. Mechanisms that are suitable to apply the coating include, but are not limited to, sprayers, trowels, and knives, among others. In one example, a first application of the coating is applied by hand with a plastic applicator in one direction, and then a second application of the coating is applied in the opposite direction. In another example, the coating is sprayed onto the substrate with a sprayer. To aid in spraying the coating, it may be desirable to manipulate the substrate in a manner that causes the film that results from the coating to have a thickness that is less that about 60 mils.

Optionally, method 200, at step 215, includes curing the coating on the substrate to form the film. Curing, as described herein, includes the process by which a liquid or semi-solid resin hardens or becomes solidified. In the present example of method 200, the coating is cured at a predetermined temperature for a predetermined period of time. It is noted, however, that other factors may cause the curing processes of the coating to occur at temperatures outside of these ranges and in a time period that is shorter and or longer than the range provided herein.

### Exemplary Formulations

Following are exemplary formulations for coatings that are found in certain embodiments of the coating systems contemplated and disclosed herein. They do not narrow the scope of the present disclosure. Rather they are meant to exemplify the types, amounts, and generally combination of the constituent components of the coatings that are used in the coating systems described herein.

### Example I

An example of the coating in an embodiment of coating system, e.g., coating system 100, includes 100 parts of the organic resin where the reaction product is formed with bisphenol A and epichlorohydrin. The coating also includes 36 parts of a diamine curing agent that is mixed with the organic resin. The resultant coating, when it is applied to the substrate at temperatures from about 22° C. and about 25° C. exhibits a durometer hardness of about Shore D 75 in less than about 105 minutes for a coating thickness from about 30 mils to about 60 mils.

### Example II

Another example of the coating in an embodiment of the coating system, e.g., coating system 100, includes 100 parts of the organic resin where the reaction product is formed with bisphenol A and epichlorohydrin. The coating also includes 36 parts of a diamine curing agent that is mixed with the organic resin. The resultant coating, when it is applied to the substrate that has a temperature from about 45° C. and about 60° C. exhibits an impact strength of about 1 in-lb/mil after it was applied to the substrate and cured at room temperature for 90 minutes.

### Experimental Results

Comparative experiments were conducted on one embodiment of coating system 100 that was made in accordance with the concepts of the present disclosure. Similar experiments were performed on other coatings that are known in the art. The results discussed herein illustrate the enhanced physical properties of the coating systems that are made in accordance with concepts of the present disclosure. For purposes of the present examples, each of the coatings discussed herein included two parts that were mixed by hand for about 90 seconds. The resultant coatings were transferred to separate containers and mixed for about an additional 90 seconds. It was then applied to the substrate.

The coating system that is used as coating system 100 in Examples III-V is the ½ L kit of Powercrete F1, manufactured by Covalence Adhesives (of Franklin, Mass.). It included 100 gm of a first part that is the organic resin (Part “A” Batch No. 045-60A) and 36 gm of a second part that is the chemical activator (Part “B” Batch No. 044-84A). These pans are mixed as discussed herein to form the coating of the coating system that is used in these experiments.

The other coating systems included a 1 L Kit of Product ID No. SP2888, manufactured by Specialty Polymer Coatings, and a 1 L Kit of Product ID No. 7200, manufactured by Denso North America, Inc. Regarding the former (i.e., SP2888), it included 100 gm of the organic resin (R.G. Base Batch No. 27100116 and 24.1 gm of the chemical activator (Hardener Batch No. 26711208). Regarding the latter (i.e., 7200), it included 100 gm of the organic resin (Protal Brush Grade Base (Batch No. 061060) and 21.5 gm of the chemical activator (Hardener 7200 (Batch No. 06L059). Each of these was mixed as described herein.

Each coating was applied by hand using a plastic applicator or putty knife. The coating was spread onto blasted metal substrates in one direction, and then the second application was applied to form a coating thickness of about 28 mils as indicated by a handheld thickness gage.

### Example III

Each coating was applied to one of the blasted metal substrates to form a coating thickness from about 50 mils to about 100 mils. The Shore hardness was checked at various times using a procedure similar to the testing procedures discussed in ASTM D2240 Standard Test Method for Rubber Property—Durometer, published by the American Society for Testing and Materials. The results are shown in Table 1,

TABLE 1

| | Cure Time (min) | Shore D Hardness |
|---|---|---|
| SP2888 | 123 | N/A* |
| 7200 | 172 | N/A* |
| Powercrete F1 | 102 | 75. |

*Material too soft to measure Shore D hardness

In this example, both of the SP2888 and 7200 coatings were too soft to measure the Shore D durometer hardness in accordance with the test standards in ASTM. The Powercrete F1 formulation made in accordance with the present disclosure, however, exhibited a durometer hardness of about Shore D 75 in about 102 minutes. This is faster than the other sample coatings in this test.

### Example IV

Each coating was applied to one of the blasted metal substrates to form a coating thickness from about 20 mils to about 35 mils. The impact strength was determined using a procedure similar to the testing procedures discussed in ASTM G14 Standard Test Method for Impact Resistance of Pipeline Coatings (Falling Weight Test), published by the American Society for Testing and Materials. The results are shown in Table 2,

TABLE 2

| | sample | Thick | Cure | Height | Strength |
|---|---|---|---|---|---|
| | # | (mil) | (min) | (in) | (#-in/mil) |
| SP2888 | 1 | 24 | 119 | 6 | N/A |
| | 2 | 26 | 119 | 6 | N/A |
| | 3 | 26 | 119 | 5 | N/A |
| | 4 | 27 | 119 | 6.5 | N/A |
| | 5 | 27 | 119 | 7 | N/A |
| | 6 | 28 | 119 | 7 | N/A |
| 7200 | 1 | 28 | 227 | 7 | N/A |
| | 2 | 28 | 227 | 7.25 | N/A |
| | 3 | 29 | 227 | 7.5 | N/A |
| | 4 | 23 | 227 | 6.5 | N/A |
| | 5 | 23 | 227 | 6.75 | N/A |
| | 6 | 22 | 227 | 6.5 | N/A |
| Powercrete F1 | 1 | 24 | 36 | 6 | N/A |
| | 2 | 22 | 36 | 6 | N/A |
| | 3 | 21 | 36 | 6 | N/A |
| | 4 | 24 | 36 | 7 | N/A |
| | 5 | 24 | 36 | 6.5 | 1.08 |
| | 6 | 24 | 36 | 6.75 | N/A |
| | 7 | 28 | 36 | 7.5 | N/A |
| | 8 | 30 | 36 | 7.5 | N/A |

In this example, the Powercrete F1 coating that is made in accordance with the present example is the only formulation to register an impact resistance within about 36 minutes of application. Neither the SP2800 or 7200 coatings registered impact strength readings, even after the cure time exceeded, respectively, 200% and 600% of the time required to register an impact resistance of about 1.08 in*#/mil on a film formed from the Powercrete F1 coating.

### Example V

Each coating was applied to one of the blasted metal substrates to form a film with a thickness from about 22 mils to about 35 mils. The samples were cured at 60° C. for 30 days. The coating disbondment was determined using a procedure similar to the testing procedures discussed in ASTM G95-87 Standard Test Method for Cathodic Disbondment of Pipeline Coatings (Attached Cell Method), published by the American Society for Testing and Materials. The results are shown in Table 3,

TABLE 3

| | Sample | Thick (mil) | Disbondment (mmr) |
|---|---|---|---|
| SP2888 | 1 | 22.1 | 6.7 |
| | 2 | 27 | 7.1 |
| | 3 | 24.2 | 5.3 |
| 7200 | 1 | 25.2 | 53.6 |
| | 2 | 25.8 | 7.8 |
| | 3 | 27.4 | 5.5 |
| Powercrete F1 | 1 | 33.3 | 4 |
| | 2 | 29 | 4.5 |
| | 3 | 28.1 | 4.6 |

In this example, the Powercrete F1 formulation exhibited significantly less delamination that the SP2888 and 7200 coatings when tested under similar conditions and using similar procedures.

While the foregoing is directed to embodiments of the present disclosure, other and further embodiments of the disclosure may be devised without departing from the basic scope thereof.

1. A composition comprising a mixture for coating a pipe, wherein,
i) the mixture cures in a predetermined time to form a thermoset polymer having a Shore D 75 hardness as measured at about 22 to about 25 degrees C, ii) the mixture does not exhibit significant dripping, sagging, or running at a thickness of about 30 mils, and iii) the mixture comprises a crosslinking agent, an epoxy resin, and at least one inorganic additive.

2. The composition of claim 1, wherein the epoxy resin comprises a product of a reaction between bisphenol A and epichlorohydrin.

3. The composition of claim 1, wherein the at least one inorganic additive comprises a catalyst.

4. The composition of claim 3, wherein the at least one inorganic additive further comprises at least one filler material.

5. The composition of claim 4, wherein the at least one inorganic additive further comprises a pigment.

6. The composition of claim 4, wherein the at least one filler material comprises talc.

7. The composition of claim 1, wherein the at least one inorganic additive comprises at least about 55 percent by weight of the mixture.

8. The composition of claim 1, wherein the crosslinking agent comprises a compound having at least two amines.

9. The composition of claim 8, wherein the crosslinking agent is selected from a group consisting of aminoethylpiperazine, tetraethylene pentamine, and mixtures thereof.

10. The composition of claim 1, wherein the crosslinking agent comprises an alkyl polyamine.

11. The composition of claim 1, wherein the mixture further comprises a plasticizer, wherein the composition has a glass transition temperature and the plasticizer lowers the glass transition temperature.

12. The composition of claim 1, wherein the mixture further comprises one or more dye compounds, wherein the one or more dye compounds are substantially soluble in the epoxy resin.

13. The composition of claim 1, wherein the mixture further comprises one or more pigment compounds, wherein the one or more pigment compounds increase opacity of the composition and decrease penetration of UV light.

14. The composition of claim 13, wherein the one or more pigment compounds is a white pigment.

15. The composition of claim 1, wherein the mixture is sprayable so that the thermoset polymer has a thickness of less than about 60 mils.

16. The composition of claim 1, wherein the mixture is applicable by hand using a tool selected from a group consisting of a trowel, knife, and plastic applicator so that the thermoset polymer has a thickness of less than about 60 mils.

17. A method of forming a thermoset polymeric coating comprising:
preparing a metallic substrate,
combining a first constituent and a second constituent,
mixing the first constituent and the second constituent forming a reactive mixture,
applying the reactive mixture to the metallic substrate, and
curing the reactive mixture for a predetermined time, wherein after the predetermined time the reactive mixture is cured to the thermoset polymeric coating which has a D 75 Shore hardness as determined at about 22 to about 25 degrees C.

18. The method of claim 17, wherein the applying step does not result in significant dripping, sagging, or running.

19. The method of claim 18, wherein the applying step includes spraying the reactive mixture onto the metallic substrate and the spraying applies an amount of the reactive mixture onto the metallic substrate sufficient to result in the thermoset polymeric coating having a thickness of about 30 to about 60 mils.

20. The method of claim 18, wherein the applying step includes using a hand tool selected from a group consisting of a trowel, knife, and plastic applicator to spread the reactive mixture onto the metallic substrate and the spreading applies an amount of the reactive mixture onto the metallic substrate sufficient to result in the thermoset polymeric coating having a thickness of about 30 to about 60 mils.

21. The method of claim 20, wherein the applying step includes using a first direction of spreading followed by a second direction of spreading, wherein the first direction of spreading and the second direction of spreading are different directions.

22. The method of claim 17, wherein the combining step includes the first constituent comprising a product of a reaction between epichlorohydrin and bisphenol A and the second constituent comprising a compound having at least two amines.

23. The method of claim 22, wherein the combining step includes the reactive mixture comprising at least one filler material and at least one catalyst.

24. The method of claim 23, wherein the combining step includes the reactive mixture comprising a nitrate and talc.

25. The method of claim 23, wherein a combination of the at least one filler material and the at least one catalyst is at least about 55 percent by weight of the reactive mixture.

26. The method of claim 17, wherein the combining step includes the first constituent and the second constituent in a weight ratio of less than or equal to about 100:36.

27. The method of claim 17, wherein the curing step includes the predetermined time of less than about 105 minutes.

28. The method of claim 17, wherein the curing step includes the predetermined time of less than about 90 minutes.
